(19) United States
(12) Patent Application Publication
(10) Pub. No.: US 2012/0242720 A1
(43) Pub. Date: Sep. 27, 2012

(54) PLASMA DISPLAY DEVICE AND METHOD FOR DRIVING PLASMA DISPLAY PANEL

(76) Inventor: Tomoyuki Saito, Osaka (JP)

(21) Appl. No.: 13/513,830

(22) PCT Filed: Dec. 15, 2010
(86) PCT No.: PCT/JP2010/007266

§ 371 Date: Jun. 4, 2012

(30) Foreign Application Priority Data
Dec. 16, 2009 (JP) 2009-284691

(51) Int. Cl. G09G 3/28; G09G 5/10

(52) U.S. Cl. 345/690; 345/60

(57) ABSTRACT

A loading phenomenon in a plasma display panel is reduced so as to enhance image display quality. For this purpose, a plasma display apparatus includes a plasma display panel and an image signal processing circuit (41). The image signal processing circuit (41) includes the number of lit cells calculator (60) for calculating the number of lit cells, a load value calculator (61) for calculating the load value of each discharge cell based on the calculation result by the number of lit cells calculator (60), a correction gain calculator (62) for calculating the correction gain of each discharge cell based on the calculation result by the load value calculator (61), a correction gain adjustor (64) for smoothing the correction gain in response to an image signal, and a corrector (69) for correcting the image signal based on the adjusted correction gain.

### TECHNICAL FIELD

The present invention relates to a plasma display apparatus and a driving method for a plasma display panel that are used in a wall-mounted television or a large monitor.

### BACKGROUND ART

A typical AC surface discharge panel used as a plasma display panel (hereinafter, simply referred to as “panel”) has a large number of discharge cells that are formed between a front plate and a rear plate facing each other. The front plate has the following elements:

a plurality of display electrode pairs, each formed of a scan electrode and a sustain electrode, disposed on a front glass substrate parallel to each other; and

a dielectric layer and a protective layer formed so as to cover the display electrode pairs.

The rear plate has the following elements:

a plurality of parallel data electrodes formed on a rear glass substrate;

a dielectric layer formed so as to cover the data electrodes;

a plurality of barrier ribs formed on the dielectric layer parallel to the data electrodes; and

phosphor layers formed on the surface of the dielectric layer and on the side faces of the barrier ribs.

The front plate and the rear plate are opposed to each other and sealed together such that the display electrode pairs three-dimensionally intersect the data electrodes. The sealed inside discharge space is filled with a discharge gas containing xenon in a partial pressure ratio of 5%, for example. Discharge cells are formed in portions where the display electrode pairs face the data electrodes. In the thus structured panel, a gas discharge generates ultraviolet rays in each discharge cell. These ultraviolet rays excite the red (R), green (G), and blue (B) phosphors such that the phosphors of the respective colors emit light for color image display.

A typically used method for driving the panel is a subfield method. In the subfield method, gradations are displayed by dividing one field into a plurality of subfields and causing light emission or no light emission in each subfield of each discharge cell. Each subfield has an initializing period, an address period, and a sustain period.

In the initializing periods, an initializing waveform is applied to the respective scan electrodes so as to cause an initializing discharge in the respective discharge cells. This initializing discharge forms wall charge necessary for the subsequent address operation and generates priming particles (excitation particles for causing an address discharge) for causing a stable address discharge in the respective discharge cells.

In the address periods, a scan pulse is sequentially applied to the scan electrodes (hereinafter, this operation being also referred to as “scanning”). Further, an address pulse is applied selectively to the data electrodes in response to a signal of an image to be displayed. Thus, an address discharge is caused between the scan electrodes and the data electrodes in the discharge cells to be lit so as to form wall charge therein (hereinafter, these operations being also generically referred to as “addressing”).

In each sustain period, a number of sustain pulses predetermined for the subfield are applied alternately to display electrode pairs, each formed of a scan electrode and a sustain electrode. This operation causes a sustain discharge in the discharge cells having undergone the address discharge, thus causing the phosphor layers of the discharge cells to emit light. (Hereinafter, causing a discharge cell to be lit by a sustain discharge is also referred to as “lighting”, and causing a discharge cell not to be lit as “non-lighting”). Thereby, the respective discharge cells are lit at luminances corresponding to the luminance weight predetermined for each subfield. In this manner, the respective discharge cells of the panel are lit at the luminances corresponding to the gradation values of the image signals. Thus, an image is displayed on the image display surface of the panel.

The subfield methods include the following driving method. In this driving method, the following operations are performed. In the initializing period of one subfield among a plurality of subfields, an all-cell initializing operation for causing an initializing discharge in all the discharge cells is performed. In the initializing periods of the other subfields, a selective initializing operation for causing an initializing discharge only in the discharge cells having undergone a sustain discharge in the immediately preceding sustain period is performed. With these operations, the luminance of a region displaying black where no sustain discharge occurs (hereinafter, “luminance of black level”) is determined by the weak light emission in the all-cell initializing operation. This can minimize the light emission unrelated to gradation display and thus improve the contrast ratio of the display image.

A difference in drive load (impedance when a driver circuit applies a driving voltage to the electrodes) between the display electrode pairs causes a difference in the voltage drop in driving voltage. This can cause a difference in emission luminance between the discharge cells even when the image signals have an equal luminance. To address this problem, the following technique is disclosed (see Patent Literature 1, for example). With this technique, the lighting pattern of the subfields in one field is changed when the driving voltage varies between the display electrode pairs.

With a recent increase in the screen size and the definition of a panel, the drive load of the panel tends to increase. In such a panel, the difference in drive load between the display electrode pairs, and thus the difference in the voltage drop in driving voltage are likely to increase.

However, in the technique disclosed in Patent Literature 1, when the difference in drive load between the display electrode pairs increases, the lighting pattern of the subfields needs to be changed considerably. As a result, the brightness of the display image can be varied in some cases.

The brightness of an image displayed on the panel is one of important factors in determining the display quality of the image. Therefore, if an unnatural change occurs in the brightness in the display image, the change can be perceived by the user as degradation of image quality.

In a large-screen, high-definition panel, a change in the brightness in the display image is likely to be perceived by the user. Thus, in a plasma display apparatus including such a panel, it is preferable to minimize a change in the brightness in the display image.

### CITATION LIST

### Patent Literature

PTL1
Japanese Patent Unexamined Publication No. 2006-184843

### SUMMARY OF THE INVENTION

A plasma display apparatus of the present invention includes a panel and an image signal processing circuit. The panel has a plurality of discharge cells that have display electrode pairs, each formed of a scan electrode and a sustain electrode. The panel has a plurality of pixels, each formed of a plurality of discharge cells emitting light of different colors. The panel is driven by a subfield method such that a plurality of subfields having respective luminance weights in one field. The image signal processing circuit converts an input image signal into image data representing lighting and non-lighting in each subfield of each discharge cell. The image signal processing circuit further includes the following elements:

the number of lit cells calculator for calculating the number of discharge cells to be lit in each display electrode pair in each subfield;

a load value calculator for calculating the load value of each discharge cell based on the calculation result by the number of lit cells calculator;

a correction gain calculator for calculating the correction gain of each discharge cell based on the calculation result by the load value calculator;

a correction gain adjustor for smoothing the correction gain in response to an image signal; and

a corrector for subtracting, from the input image signal, the multiplication result of the adjusted correction gain output from the correction gain adjustor and the input image signal.

With this configuration, a difference in drive load between display electrode pairs can be detected accurately and a loading correction optimum for the lighting state of each discharge cell can be made. Further, in an area where a change in brightness between adjacent pixels is determined to be relatively large, the correction gains calculated in the correction gain calculator can be used for a loading correction. In an area where a change in brightness between adjacent pixels is determined to be relatively small, the smoothed correction gains can be used for a loading correction. Therefore, a more accurate loading correction can be made by preventing an unnatural change in the luminance in the display image. This can considerably enhance the image display quality in the plasma display apparatus including a large-screen, high-definition panel.

In a driving method for a panel of the present invention, the panel has a plurality of discharge cells that have display electrode pairs, each formed of a scan electrode and a sustain electrode, and the panel has a plurality of pixels, each formed of a plurality of discharge cells emitting light of different colors. The panel is driven by a subfield method such that a plurality of subfields having respective luminance weights in one field.

The driving method includes:

calculating the number of discharge cells to be lit in each display electrode pair and in each subfield;

calculating the load value of each discharge cell based on the number of discharge cells to be lit;

calculating the correction gain of each discharge cell based on the load value;

smoothing the correction gain in response to an image signal so as to generate an adjusted correction gain; and

multiplying the adjusted correction gain by the input image signal and subtracting the multiplication result from the input image signal for providing the input image signal with a loading correction.

With this operation, a difference in drive load between display electrode pairs can be detected accurately and a loading correction optimum for the lighting state of each discharge cell can be made. Further, in an area where a change in brightness between adjacent pixels is determined to be relatively large, the calculated correction gains can be used for a loading correction. In an area where a change in brightness between adjacent pixels is determined to be relatively small, the smoothed correction gains can be used for a loading correction. Therefore, a more accurate loading correction can be made by preventing an unnatural change in the luminance in the display image. This can considerably enhance the image display quality in the plasma display apparatus including a large-screen, high-definition panel.

### BRIEF DESCRIPTION OF DRAWINGS

FIG. 1 is an exploded perspective view showing a structure of a panel in accordance with an exemplary embodiment of the present invention.

FIG. 2 is an electrode array diagram of the panel in accordance with the exemplary embodiment.

FIG. 3 is a chart of driving voltage waveforms applied to the respective electrodes of the panel in accordance with the exemplary embodiment.

FIG. 4 is a circuit block diagram of a plasma display apparatus in accordance with the exemplary embodiment.

FIG. 5A is a schematic drawing for explaining a difference in the emission luminance caused by a change in drive load.

FIG. 5B is a schematic drawing for explaining the difference in the emission luminance caused by the change in drive load.

FIG. 6A is a diagram for schematically explaining a loading phenomenon.

FIG. 6B is a diagram for schematically explaining a loading phenomenon.

FIG. 6C is a diagram for schematically explaining a loading phenomenon.

FIG. 6D is a diagram for schematically explaining a loading phenomenon.

FIG. 7 is a drawing for schematically explaining a loading correction in accordance with the exemplary embodiment of the present invention.

FIG. 8 is a circuit block diagram of an image signal processing circuit in accordance with the exemplary embodiment.

FIG. 9 is a schematic drawing for explaining a method for calculating a “load value” in accordance with the exemplary embodiment.

FIG. 10 is a schematic drawing for explaining a method for calculating a “maximum load value” in accordance with the exemplary embodiment.

FIG. 11 is a circuit block diagram of a correction gain adjustor in accordance with the exemplary embodiment.

FIG. 12 is a schematic diagram for explaining an example of an adjusted correction gain in accordance with the exemplary embodiment.

FIG. 13 is a schematic diagram for explaining another example of the adjusted correction gain in accordance with the exemplary embodiment.

FIG. 14 is a circuit block diagram showing another configuration example of the correction gain adjustor in accordance with the exemplary embodiment.

### DESCRIPTION OF EMBODIMENT

Hereinafter, a description is provided for a plasma display apparatus in accordance with the exemplary embodiment of the present invention with reference to the accompanying drawings.

### Exemplary Embodiment

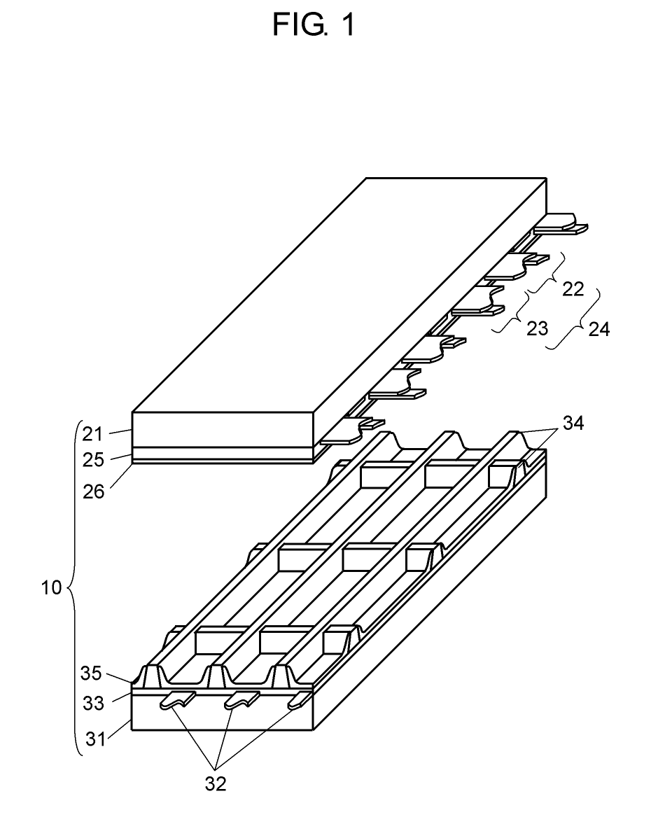

FIG. 1 is an exploded perspective view showing a structure of panel 10 in accordance with the exemplary embodiment of the present invention. A plurality of display electrode pairs 24, each formed of scan electrode 22 and sustain electrode 23, is formed on glass front substrate 21. Dielectric layer 25 is formed so as to cover scan electrodes 22 and sustain electrodes 23. Protective layer 26 is formed over dielectric layer 25. Protective layer 26 is made of a material predominantly composed of magnesium oxide (MgO).

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 each for emitting red (R) light, green (G) light, or blue (B) light are disposed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a neon-xenon mixture gas, for example, is sealed as a discharge gas. In this exemplary embodiment, in order to enhance the emission efficiency, a discharge gas having a xenon partial pressure of approximately 10% is used.

The discharge space is partitioned into a plurality of compartments by barrier ribs 34. Discharge cells are formed in the intersecting parts of display electrode pairs 24 and data electrodes 32. Discharge and light emission (lighting) of these discharge cells allow display of a color image on panel 10.

In panel 10, three consecutive discharge cells arranged in the extending direction of display electrode pair 24, i.e. a discharge cell for emitting red (R) light, a discharge cell for emitting green (G) light, and a discharge cell for emitting blue (B) light, form one pixel. Hereinafter, a discharge cell for emitting red light is referred to as an R discharge cell, a discharge cell for emitting green light as a G discharge cell, and a discharge cell for emitting blue light as a B discharge cell.

The structure of panel 10 is not limited to the above. The panel may include barrier ribs in a stripe pattern, for example. The mixture ratio of the discharge gas is not limited to the above numerical value, and other mixture ratios may be used.

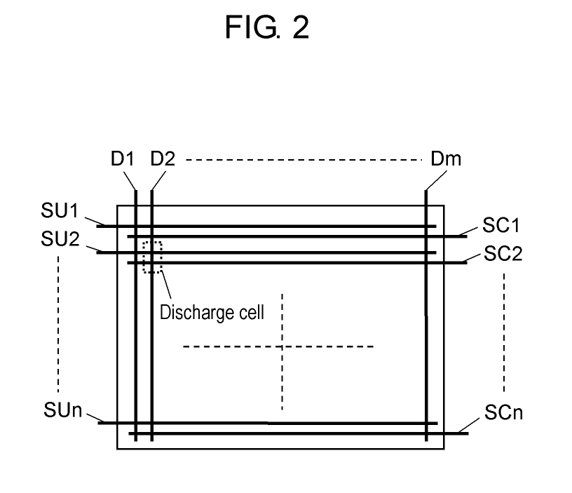

FIG. 2 is an electrode array diagram of panel 10 in accordance with the exemplary embodiment of the present invention. Panel 10 has n scan electrode SC1-scan electrode SCn (scan electrodes 22 in FIG. 1) and n sustain electrode SU1-sustain electrode SUn (sustain electrodes 23 in FIG. 1) long in the line direction, and m data electrode D1-data electrode Dm (data electrodes 32 in FIG. 1) long in the column direction. A discharge cell is formed in the part where a pair of scan electrode SCi (i=1−n) and sustain electrode SUi intersects one data electrode Dj (j=1−m). That is, one display electrode pair 24 has m discharge cells, which form m/3 pixels. Then, m×n discharge cells are formed in the discharge space, and the area having m×n discharge cells is the image display surface of panel 10. For example, in a panel having 1920×1080 pixels, m=1920×3 and n=1080.

Next, driving voltage waveforms for driving panel 10 and the operation thereof are outlined. The plasma display apparatus of this exemplary embodiment displays gradations by a subfield method. In the subfield method, one field is divided into a plurality of subfields along a temporal axis, and a luminance weight is set for each subfield. By controlling light emission and no light emission in each subfield of each discharge cell, an image is displayed on panel 10.

In the example described in this exemplary embodiment, one field is formed of eight subfields (the first SF, the second SF, . . . , the eighth SF), and the respective subfields have luminance weights of 1, 2, 4, 8, 16, 32, 64, and 128 such that the temporally later subfields have the heavier luminance weights. In this structure, each of the R signal, the G signal, and the B signal can be displayed with 256 gradations from 0 through 255.

In the initializing period of one subfield among the plurality of subfields, an all-cell initializing operation for causing an initializing discharge in all the discharge cells is performed. In the initializing periods of the other subfields, a selective initializing operation for causing an initializing discharge selectively in the discharge cells having undergone a sustain discharge in the sustain period of the immediately preceding subfield is performed. These operations can minimize the light emission unrelated to gradation display, reduce the emission luminance in a region displaying black where no sustain discharge occurs, and improve the contrast ratio of an image displayed on panel 10. Hereinafter, a subfield where an all-cell initializing operation is performed is referred to as “all-cell initializing subfield”, and a subfield where a selective initializing operation is performed is referred to as “selective initializing subfield”.

In the example described in this exemplary embodiment, the all-cell initializing operation is performed in the initializing period of the first SF, and the selective initializing operation is performed in the initializing periods of the second SF through the eighth SF. With these operations, the light emission unrelated to image display is only the light emission caused by the discharge in the all-cell initializing operation in the first SF. Thus, the luminance of black level, i.e. the luminance in a region displaying black where no sustain discharge occurs, is determined only by the weak light emission in the all-cell initializing operation. Thereby, an image of high contrast can be displayed on panel 10.

In the sustain period of each subfield, sustain pulses equal in number to the luminance weight of the subfield multiplied by a predetermined proportionality factor are applied to respective display electrode pairs 24. This proportionality factor is a luminance magnification.

However, in this exemplary embodiment, the number of subfields forming one field, or the luminance weight of each subfield is not limited to the above values. The subfield structure may be switched in response to an image signal, for example.

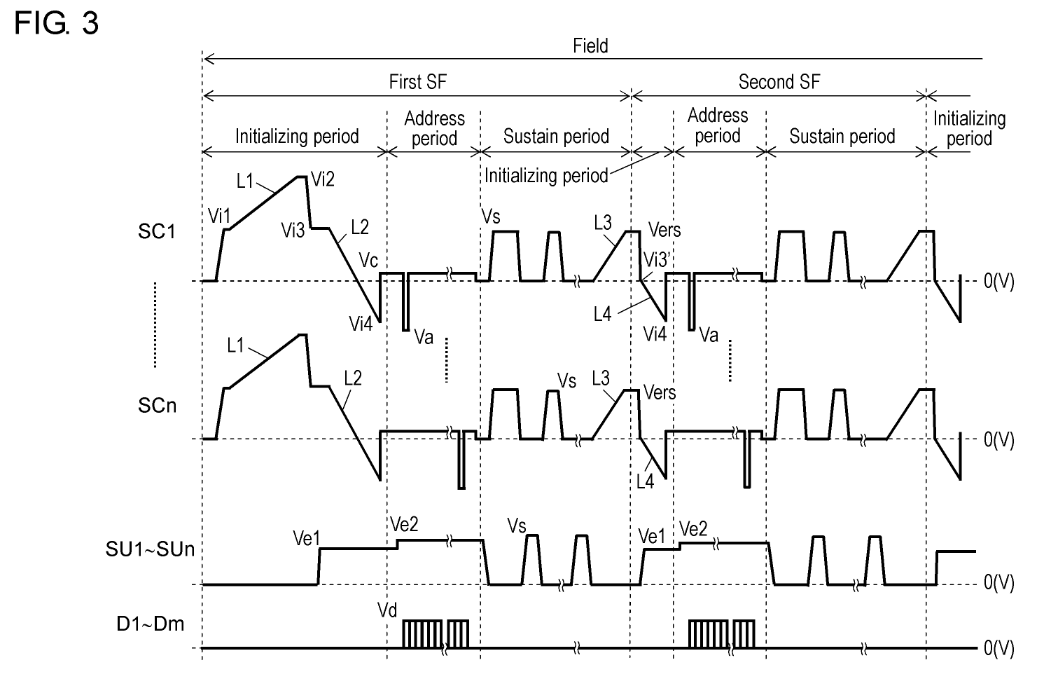

FIG. 3 is a chart of driving voltage waveforms applied to the respective electrodes of panel 10 in accordance with the exemplary embodiment of the present invention. FIG. 3 shows driving voltage waveforms applied to the following electrodes: scan electrode SC1 to undergo an address operation first in the address periods: scan electrode SCn to undergo an address operation last in the address periods; sustain electrode SU1-sustain electrode SUn; and data electrode D1-data electrode Dm.

FIG. 3 shows driving voltage waveforms in two subfields: the first subfield (first SF), i.e. an all-cell initializing subfield; and the second subfield (second SF), i.e. a selective initializing subfield. The driving voltage waveforms in the other subfields are substantially the same as the driving voltage waveforms in the second SF except for the number of sustain pulses generated in the sustain period. Scan electrode SCi, sustain electrode SUi, and data electrode Dk in the following description show the electrodes selected among the corresponding electrodes in response to image data (data representing lighting and non-lighting in each subfield).

First, a description is provided for the first SF, an all-cell initializing subfield.

In the first half of the initializing period of the first SF, 0 (V) is applied to each of data electrode D1-data electrode Dm and sustain electrode SU1-sustain electrode SUn, and voltage V11 is applied to scan electrode SC1-scan electrode SCn. Voltage V11 is set to a voltage lower than a discharge start voltage with respect to sustain electrode SU1-sustain electrode SUn. Further, scan electrode SC1-scan electrode SCn are applied with a ramp waveform voltage that gently rises from voltage V11 toward voltage V12. Hereinafter, this ramp waveform voltage is referred to as “up-ramp voltage L1”. Voltage V12 is set to a voltage exceeding the discharge start voltage with respect to sustain electrode SU1-sustain electrode SUn. Examples of the gradient of this up-ramp voltage L1 include a numerical value of approximately 1.3 V/μsec.

While up-ramp voltage L1 is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm. Then, negative wall voltage accumulates on scan electrode SC1-scan electrode SCn; positive wall voltage accumulates on data electrode D1-data electrode Dm and sustain electrode SU1-sustain electrode SUn. Here, this wall voltage on the electrodes means the voltage generated by the wall charge that is accumulated on the dielectric layers covering the electrodes, the protective layer, the phosphor layers, or the like.

In the second half of the initializing period, positive voltage Ve1 is applied to sustain electrode SU1-sustain electrode SUn, and 0 (V) is applied to data electrode D1-data electrode Dm. Scan electrode SC1-scan electrode SCn are applied with a ramp waveform voltage that gently falls from voltage V13 toward negative voltage V14. Hereinafter, this ramp waveform voltage is referred to as “down-ramp voltage L2”. Voltage V13 is set to a voltage lower than the discharge start voltage with respect to sustain electrode SU1-sustain electrode SUn. Voltage V14 is set to a voltage exceeding the discharge start voltage. Examples of the gradient of this down-ramp voltage L2 include a numerical value of approximately −2.5 V/μsec.

While down-ramp voltage L2 is applied to scan electrode SC1-scan electrode SCn, a weak initializing discharge occurs between scan electrode SC1-scan electrode SCn and sustain electrode SU1-sustain electrode SUn, and between scan electrode SC1-scan electrode SCn and data electrode D1-data electrode Dm. This weak discharge reduces the negative wall voltage on scan electrode SC1-scan electrode SCn, and the positive wall voltage on sustain electrode SU1-sustain electrode SUn, and adjusts the positive wall voltage on data electrode D1-data electrode Dm to a value appropriate for the address operation. In this manner, the all-cell initializing operation for causing an initializing discharge in all the discharge cells is completed.

In the subsequent address period, a scan pulse at voltage Va is applied sequentially to scan electrode SC1-scan electrode SCn. An address pulse at positive voltage Vd is applied to data electrode Dk (k=1−m) corresponding to a discharge cell to be lit among data electrode D1-data electrode Dm. Thus, an address discharge is caused selectively in the corresponding discharge cells.

Specifically, voltage Ve2 is applied to sustain electrode SU1-sustain electrode SUn, and voltage Vc (voltage Vc=voltage Va+voltage Vsc) is applied to scan electrode SC1-scan electrode SCn.

Next, a scan pulse at negative voltage Va is applied to scan electrode SC1 in the first line, and an address pulse at positive voltage Vd is applied to data electrode Dk (k=1−m) of the discharge cell to be lit in the first line among data electrode D1-data electrode Dm. At this time, the voltage difference in the intersecting part of data electrode Dk and scan electrode SC1 is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds the discharge start voltage, and a discharge occurs between data electrode Dk and scan electrode SC1.

Since voltage Ve2 is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve2-voltage Va). At this time, setting voltage Ve2 to a voltage value slightly lower than the discharge start voltage can make a state where a discharge is likely to occur but does not actually occur between sustain electrode SU1 and scan electrode SC1.

With this setting, the discharge caused between data electrode Dk and scan electrode SC1 can trigger a discharge between the areas of sustain electrode SU1 and scan electrode SC1 intersecting data electrode Dk. Thus, an address discharge occurs in the discharge cells to be lit. Positive wall voltage accumulates on scan electrode SC1 and negative wall voltage accumulates on sustain electrode SU1. Negative wall voltage also accumulates on data electrode Dk.

In this manner, the address operation is performed so as to cause the address discharge in the discharge cells to be lit in the first line and accumulate wall voltages on the corresponding electrodes. In contrast, the voltage in the intersecting parts of scan electrode SC1 and data electrodes 32 applied with no address pulse does not exceed the discharge start voltage, and thus no address discharge occurs. The above address operation is repeated until the operation reaches the discharge cells in the n-th line, and the address period is completed.

In the subsequent sustain period, sustain pulses equal in number to the luminance weight multiplied by a predetermined luminance magnification are applied alternately to display electrode pairs 24. Thereby, a sustain discharge occurs in the discharge cells having undergone the address discharge, and causes the discharge cells to be lit.

In this sustain period, first, a sustain pulse at positive voltage Vs is applied to scan electrode SC1-scan electrode SCn, and a ground electric potential as a base electric potential, i.e. 0 (V), is applied to sustain electrode SU1-sustain electrode SUn. Then, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thereby, the voltage difference between scan electrode SCi and sustain electrode SUi exceeds the discharge start voltage, and a sustain discharge occurs between scan electrode SCi and sustain electrode SUi. Then, ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, 0 (V) as the base electric potential is applied to scan electrode SC1-scan electrode SCn, and a sustain pulse is applied to sustain electrode SU1-sustain electrode SUn. In the discharge cell having undergone the sustain discharge, the voltage difference between sustain electrode SUi and scan electrode SCi exceeds the discharge start voltage. Thereby, a sustain discharge occurs between sustain electrode SUi and scan electrode SCi again. Thus, negative wall voltage accumulates on sustain electrode SUi, and positive wall voltage accumulates on scan electrode SCi.

Similarly, sustain pulses equal in number to the luminance weight multiplied by the luminance magnification are applied alternately to scan electrode SC1-scan electrode SCn and sustain electrode SU1-sustain electrode SUn. Thereby, the sustain discharge is continued in the discharge cells having undergone the address discharge in the address period.

After the sustain pulses have been generated in the sustain period, scan electrode SC1-scan electrode SCn are applied with a ramp waveform voltage that gently rises from 0 (V) toward voltage Vers while sustain electrode SU1-sustain electrode SUn and data electrode D1-data electrode Dm are applied with 0 (V). Hereinafter, this ramp waveform voltage is referred to as “erasing ramp voltage L3”.

Erasing ramp voltage L3 is set so as to have a gradient steeper than that of up-ramp voltage L1. Examples of the gradient of erasing ramp voltage L3 include a numerical value of approximately 10 V/μsec. Voltage Vers is set to a voltage exceeding the discharge start voltage. Thereby, a weak discharge occurs between sustain electrode SUi and scan electrode SCi in a discharge cell having undergone the sustain discharge. This weak discharge continuously occurs while the voltage applied to scan electrode SC1-scan electrode SCn is rising above the discharge start voltage.

At this time, the charged particles generated by this weak discharge accumulate on sustain electrode SUi and scan electrode SCi so as to reduce the voltage difference between sustain electrode SUi and scan electrode SCi. Therefore, in a discharge cell having undergone the sustain discharge, a part or the whole of the wall voltage on scan electrode SCi and sustain electrode SUi is erased while the positive wall charge is left on data electrode Dk. That is, the discharge caused by erasing ramp voltage L3 works as “erasing discharge” for erasing unnecessary wall charge accumulated in the discharge cell having undergone the sustain discharge.

After the rising voltage has reached predetermined voltage Vers, the voltage applied to scan electrode SC1-scan electrode SCn is lowered to 0 (V) as the base electric potential. Thus, the sustain operation in the sustain period is completed.

In the initializing period of the second SF, the respective electrodes are applied with driving voltage waveforms where those in the first half of the initializing period of the first SF are omitted. Sustain electrode SU1-sustain electrode SUn are applied with voltage Ve1, and data electrode D1-data electrode Dm are applied with voltage 0 (V). Scan electrode SC1-scan electrode SCn are applied with down-ramp voltage L4, which gently falls from voltage Vi3′ (e.g. voltage 0 (V)) lower than the discharge start voltage toward negative voltage V14 exceeding the discharge start voltage. Examples of the gradient of this down-ramp voltage L4 include a numerical value of approximately −2.5 V/μsec.

This voltage application causes a weak initializing discharge in the discharge cells having undergone a sustain discharge in the sustain period of the immediately preceding subfield (the first SF in FIG. 3). This weak discharge reduces the wall voltage on scan electrode SCi and sustain electrode SUi, and adjusts the wall voltage on data electrode Dk to a value appropriate for the address operation. In contrast, in the discharge cells having undergone no sustain discharge in the sustain period of the immediately preceding subfield, no initializing discharge occurs, and the wall charge at the completion of the initializing period of the immediately preceding subfield is maintained. In this manner, the initializing operation in the second SF is a selective initializing operation for causing an initializing discharge in the discharge cells having undergone a sustain discharge in the sustain period of the immediately preceding subfield.

In the address period and the sustain period of the second SF, the respective electrodes are applied with driving voltage waveforms same as those in the address period and the sustain period of the first SF except for the number of sustain pulses. In the third SF and those thereafter, the respective electrodes are applied with the driving voltage waveforms same as those in the second SF except for the number of sustain pulses.

The above description has outlined the driving voltage waveforms applied to the respective electrodes of panel 10 in this exemplary embodiment.

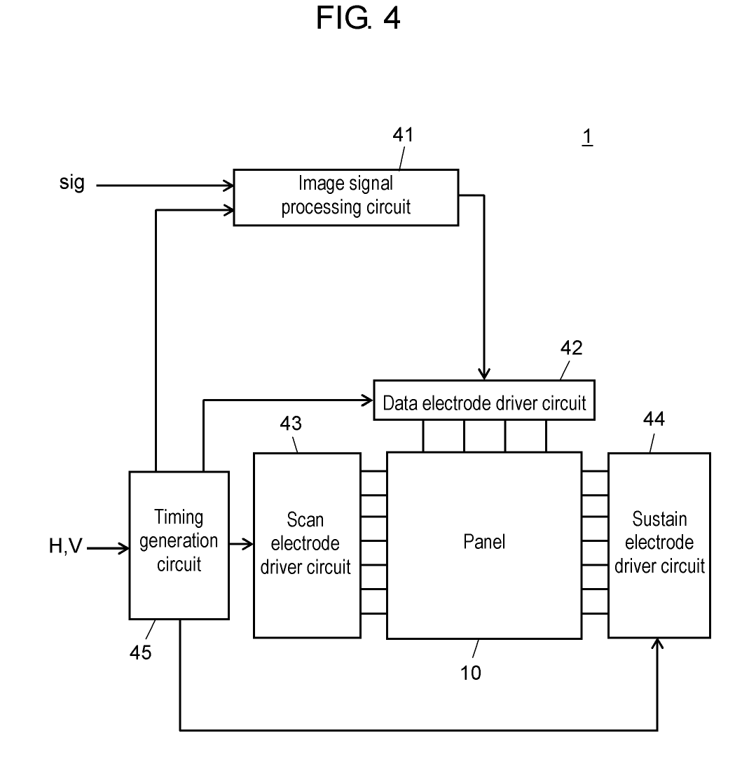

Next, a description is provided for a configuration of a plasma display apparatus in this exemplary embodiment. FIG. 4 is a circuit block diagram of plasma display apparatus 1 in accordance with the exemplary embodiment of the present invention.

Plasma display apparatus 1 has the following elements:
panel 10;
image signal processing circuit 41;
data electrode driver circuit 42;
scan electrode driver circuit 43;
sustain electrode driver circuit 44;
timing generation circuit 45; and
electric power supply circuits (not shown) for supplying electric power necessary for each circuit block.

Image signal processing circuit 41 allocates gradation values to the respective discharge cells, based on input image signal sig. The image signal processing circuit converts the gradation values into image data representing light emission and no light emission in each subfield.

For instance, when input image signal sig includes an R signal, a G signal, and a B signal, the image signal processing circuit allocates the R, G, and B gradation values to the respective discharge cells, based on the R signal, the G signal, and the B signal. When input image signal sig includes a luminance signal (Y signal) and a chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield.

In this exemplary embodiment, as described later, image signal processing circuit 41 makes a correction referred to as “loading correction” on the image signal. Based on the image signal having undergone this correction, image signal processing circuit 41 allocates the R, G, and B image data to the corresponding discharge cells.

Timing generation circuit 45 generates various timing signals for controlling the operation of each circuit block in response to horizontal synchronization signal H and vertical synchronization signal V. The timing generation circuit supplies the generated timing signals to each circuit block (image signal processing circuit 41, data electrode driver circuit 42, scan electrode driver circuit 43, sustain electrode driver circuit 44, or the like).

Scan electrode driver circuit 43 has an initializing waveform generation circuit, a sustain pulse generation circuit, and a scan pulse generation circuit (these circuit being not shown). The initializing waveform generation circuit generates initializing waveforms to be applied to scan electrode SC1-scan electrode SCn in the initializing periods. The sustain pulse generation circuit generates sustain pulses to be applied to scan electrode SC1-scan electrode SCn in the sustain periods. The scan pulse generation circuit has a plurality of scan electrode driver ICs (scan ICs) and generates scan pulses to be applied to scan electrode SC1-scan electrode SCn in the address periods. Scan electrode driver circuit 43 drives each of scan electrode SC1-scan electrode SCn, in response to the timing signals supplied from timing generation circuit 45.

Data electrode driver circuit 42 converts data forming image data in each subfield into signals corresponding to each of data electrode D1-data electrode Dm. The data electrode driver circuit drives each of data electrode D1-data electrode Dm in response to the above signals and the timing signals supplied from timing generation circuit 45.

Sustain electrode driver circuit 44 has a sustain pulse generation circuit and a circuit for generating voltage Ve1 and voltage Ve2 (not shown), and drives sustain electrode SU1-sustain electrode SUn in response to the timing signals supplied from timing generation circuit 45.

Next, a description is provided for a difference in the emission luminance caused by a change in drive load.

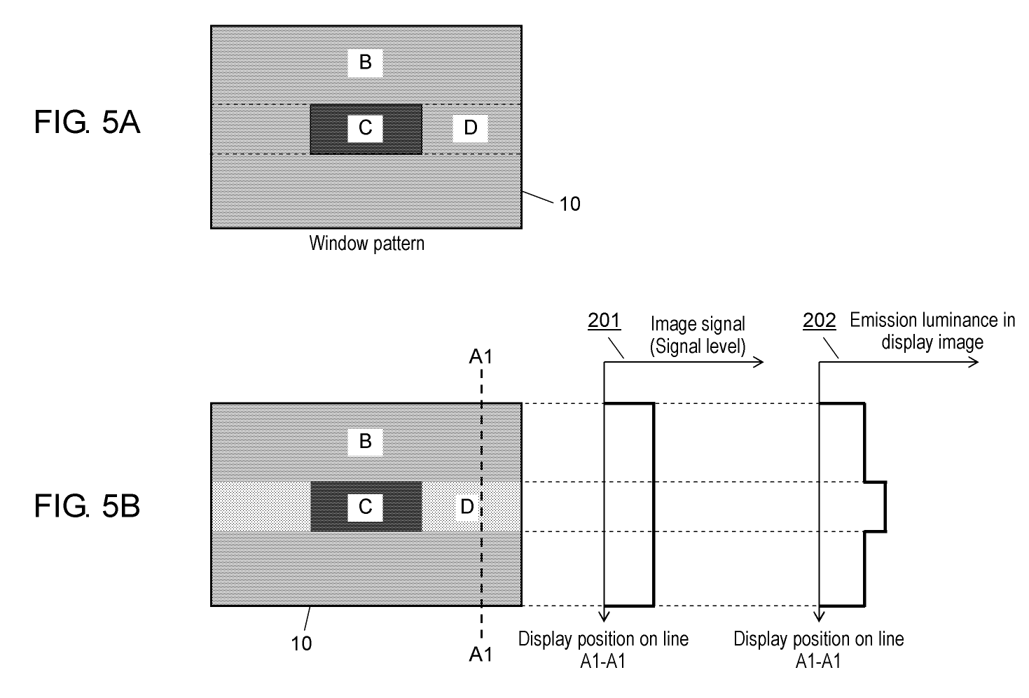

FIG. 5A and FIG. 5B are schematic drawings for explaining a difference in the emission luminance caused by a change in drive load. FIG. 5A shows an ideal display image when an image generally called “window pattern” is displayed on panel 10. Region B and region D shown in the drawings are at an equal signal level (e.g. 20%), and region C is at a signal level (e.g. 5%) lower than that of region B and region D. The “signal level” in this exemplary embodiment may be the gradation value of a luminance signal or may be the gradation value of an R signal, the gradation value of a B signal, and the gradation value of a G signal.

FIG. 5B includes a diagram schematically showing a display image when the “window pattern” of FIG. 5A is shown on panel 10, and diagrams showing signal level 201 and emission luminance 202. In panel 10 of FIG. 5B, display electrode pairs 24 are arranged so as to extend in the line direction (the direction parallel to the long side of panel 10, the horizontal direction in the diagram), similar to those in panel 10 shown in FIG. 2. Signal level 201 of FIG. 5B shows a signal level of an image signal on line A1-A1 in panel 10 of FIG. 5B. The horizontal axis shows the magnitude of the signal level of the image signal; the vertical axis shows the display position on line A1-A1 in panel 10. Emission luminance 202 of FIG. 5B shows an emission luminance in the display image on line A1-A1 in panel 10. The horizontal axis shows the magnitude of the emission luminance in the display image; the vertical axis shows the display position on line A1-A1 in panel 10.

As shown in FIG. 5B, when the “window pattern” is displayed on panel 10, region B and region D can have different emission luminances as shown in emission luminance 202 even though region B and region D are at an equal signal level as shown in signal level 201. This is considered for the following reason.

Display electrode pairs 24 are arranged so as to extend in the line direction (the direction parallel to the long side of panel 10, the horizontal direction in the diagram). Thus, when the “window pattern” is displayed on panel 10 as shown in panel 10 of FIG. 5B, some of display electrode pairs 24 pass only through region B and some of display electrode pairs 24 pass through both region C and region D. The drive load of display electrode pairs 24 passing through region C and region D is smaller than the drive load of display electrode pairs 24 passing through region B. This is for the following reason. Since the signal level and thus the emission luminance in region C are lower than those in region B, the discharge current that flows through display electrode pairs 24 passing through region C and region D is smaller than the discharge current that flows through display electrode pairs 24 passing through region B.

Therefore, in display electrode pairs 24 passing through region C and region D, a voltage drop in driving voltage is smaller than that in display electrode pairs 24 passing through region B. That is, the following phenomenon is considered to occur. The voltage drop in sustain pulse in display electrode pairs 24 passing through region C and region D is smaller than that in display electrode pairs 24 passing through region B. As a result, the discharge intensity of the sustain discharge in the discharge cells in region D is higher than that of the sustain discharge in the discharge cells in region B. Then, region D has an emission luminance higher than that of region B, even though both regions are at an equal signal level. Hereinafter, such a phenomenon is referred to as “loading phenomenon”. That is, the loading phenomenon is a phenomenon such that a difference in drive load between discharge electrode pairs 24 in the respective lines causes a difference in emission luminance between the discharge cells in the respective lines.

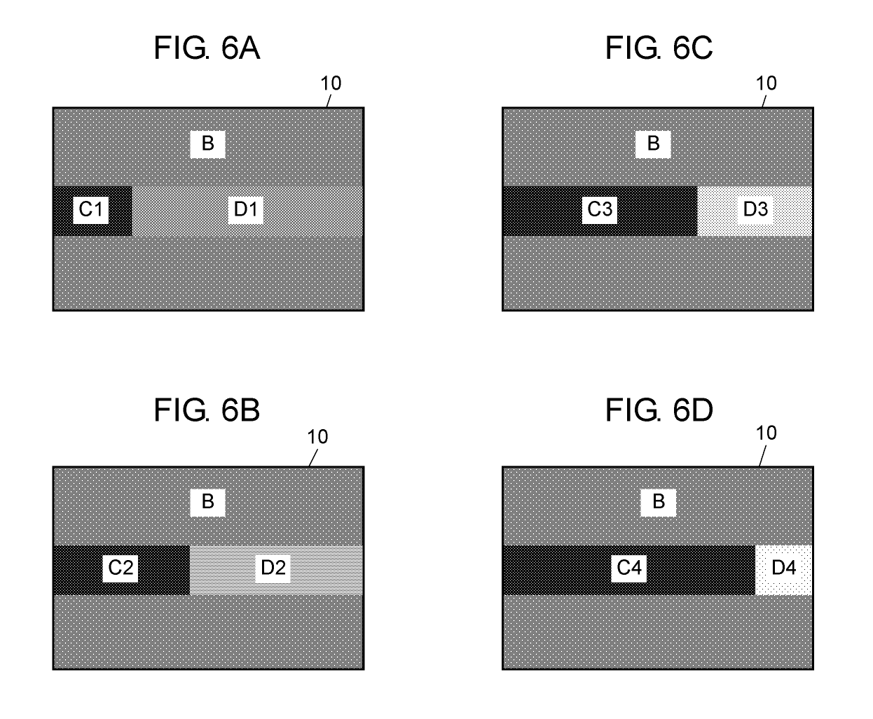

FIG. 6A, FIG. 6B, FIG. 6C, and FIG. 6D are diagrams each for schematically explaining a loading phenomenon. Each of these diagrams schematically shows a display image displayed on panel 10 while the area of region C at a low signal level is gradually changed in the “window pattern”. Each of region D1 in FIG. 6A, region D2 in FIG. 6B, region D3 in FIG. 6C, and region D4 in FIG. 6D is at a signal level (e.g. 20%) equal to that of region B. Each of region C1 in FIG. 6A, region C2 in FIG. 6B, region C3 in FIG. 6C, and region C4 in FIG. 6D is at an equal signal level (e.g. 5%).

As shown in FIG. 6A, FIG. 6B, FIG. 6C, and FIG. 6D, as the area of region C increases in the order of region C1, region C2, region C3, and region C4, the drive load of display electrode pairs 24 passing through region C and region D decreases. As a result, the discharge intensity of the discharge cells in region D gradually increases and the emission luminance of region D gradually increases in the order of region D1, region D2, region D3, and region D4. In this manner, the emission luminance increased by a loading phenomenon changes as the drive load varies. This exemplary embodiment is intended to reduce this loading phenomenon and enhance the image display quality in plasma display apparatus 1. The processing performed to reduce the loading phenomenon is referred to as “loading correction”.

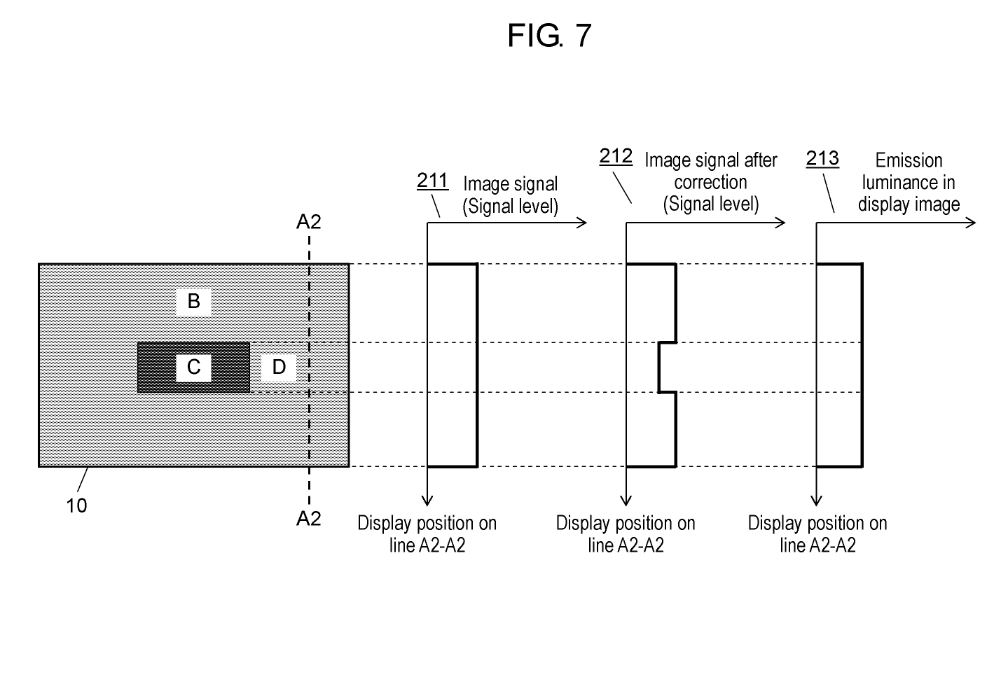

FIG. 7 is a drawing for schematically explaining a loading correction in accordance with the exemplary embodiment of the present invention. This drawing includes a diagram schematically showing a display image when the “window pattern” of FIG. 5A is shown on panel 10, and diagrams showing signal level 211, signal level 212, and emission luminance 213. The display image on panel 10 of FIG. 7 schematically shows a display image when the “window pattern” of FIG. 5A is displayed on panel 10 after the loading correction of this exemplary embodiment has been made. Signal level 211 of FIG. 7 shows a signal level of an image signal on line A2-A2 shown in panel 10 of FIG. 7. The horizontal axis shows the magnitude of the signal level of the image signal; the vertical axis shows the display position on line A2-A2 in panel 10. Signal level 212 of FIG. 7 shows the signal level of the image signal on line A2-A2 after the loading correction of this exemplary embodiment has been made. The horizontal axis shows the magnitude of the signal level of the image signal after the loading correction; the vertical axis shows the display position on line A2-A2 in panel 10. Emission luminance 213 of FIG. 7 shows an emission luminance in the display image on line A2-A2 in panel 10. The horizontal axis shows the magnitude of the emission luminance in the display image; the vertical axis shows the display position on line A2-A2 in panel 10.

In this exemplary embodiment, a loading correction is made in the following manner. For each discharge cell, a correction value based on the drive load of display electrode pair 24 passing through a discharge cell is calculated so as to correct an image signal. For example, when an image as shown in panel 10 of FIG. 7 is displayed on panel 10, it is determined that display electrode pairs 24 passing through region D also pass through region C and thus have a smaller drive load, although region B and region D are at an equal signal level. Then, the signal level in region D is corrected as shown in signal level 212 of FIG. 7. With this correction, as shown in emission luminance 213 of FIG. 7, the magnitudes of emission luminance in region B and region D in the display image are equalized to each other such that the loading phenomenon is reduced.

In this manner, in this exemplary embodiment, the image signal in a region where a loading phenomenon is likely to occur is corrected such that the emission luminance in the region of the display image is reduced. Thereby, the loading phenomenon is reduced. At this time, in this exemplary embodiment, a correction gain adjustor to be described later makes an adjustment for smoothing the correction gain that has been calculated for the loading correction, in response to the image signal. The loading correction is made using the adjusted correction gain.

The loading correction in this exemplary embodiment is detailed.

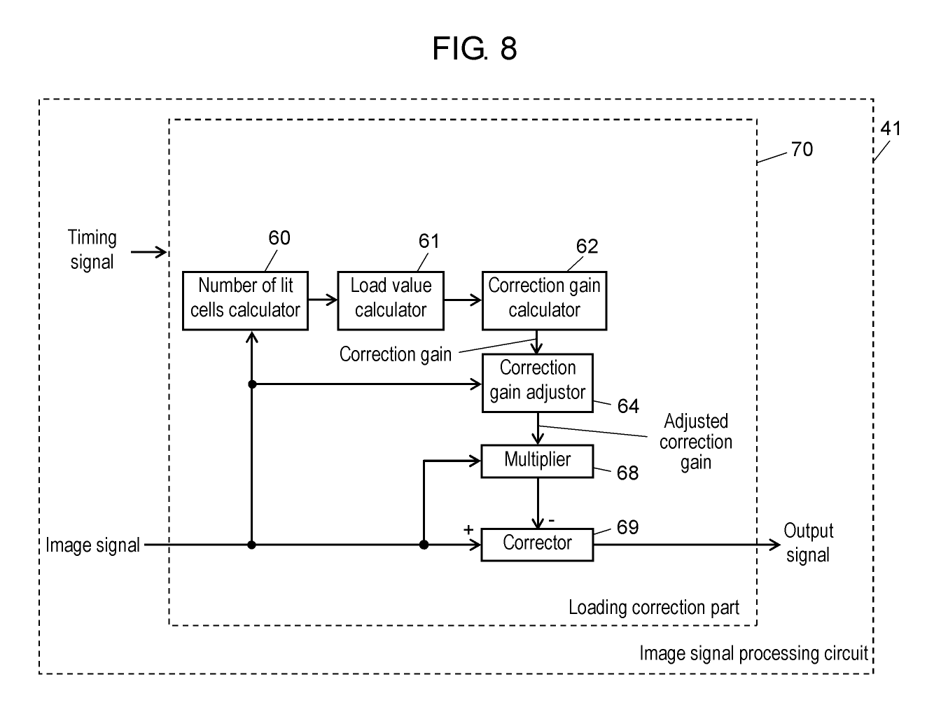

FIG. 8 is a circuit block diagram of image signal processing circuit 41 in accordance with the exemplary embodiment of the present invention. In FIG. 8, the blocks related to the loading correction in this exemplary embodiment are shown, and the other circuit blocks are omitted.

Image signal processing circuit 41 includes loading correction part 70. Loading correction part 70 has the following elements:
number of lit cells calculator 60;
load value calculator 61;
correction gain calculator 62;
correction gain adjustor 64;
multiplier 68; and
corrector 69.

Number of lit cells calculator 60 calculates the number of discharge cells to be lit in each display electrode pair 24 in each subfield. Hereinafter, a discharge cell to be lit is referred to as “lit cell”, and a discharge cell to be unlit as “unlit cell”.

Upon receiving the calculation result in number of lit cells calculator 60, load value calculator 61 performs operations based on the method for calculating a drive load in this exemplary embodiment. With these operations, a “load value” and a “maximum load value” to be described later are calculated.

Correction gain calculator 62 calculates a correction gain, based on the calculation result in load value calculator 61.

In response to an image signal, correction gain adjustor 64 makes an adjustment for smoothing the correction gain output from correction gain calculator 62, and generates an adjusted correction gain. Correction gain adjustor 64 is detailed later.

Multiplier 68 multiplies the adjusted correction gain output from correction gain adjustor 64 by the image signal, and outputs the obtained result as a correction signal.

Corrector 69 subtracts the correction signal output from multiplier 68, from the input image signal, and outputs the obtained result as a corrected image signal.

Next, a description is provided for the method for calculating a correction gain in this exemplary embodiment. In this exemplary embodiment, this operation is performed in number of lit cells calculator 60, load value calculator 61, and correction gain calculator 62.

In this exemplary embodiment, two numerical values referred to as “load value” and “maximum load value” are calculated, based on the calculation result in number of lit cells calculator 60. These “load value” and “maximum load value” are the numerical values used to estimate the amount of loading phenomenon in a discharge cell.

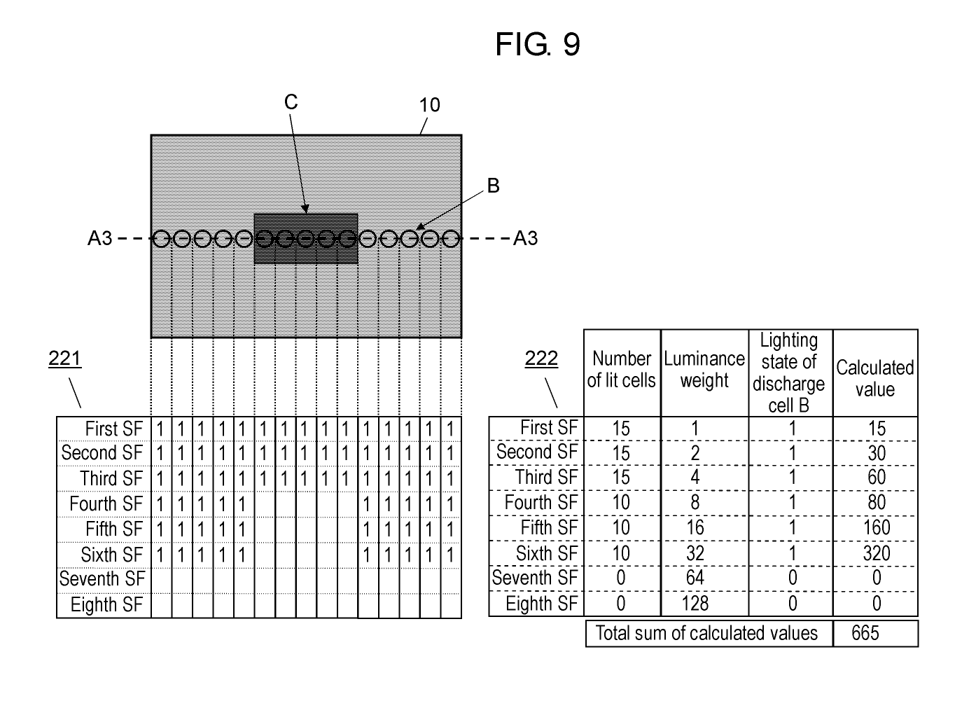

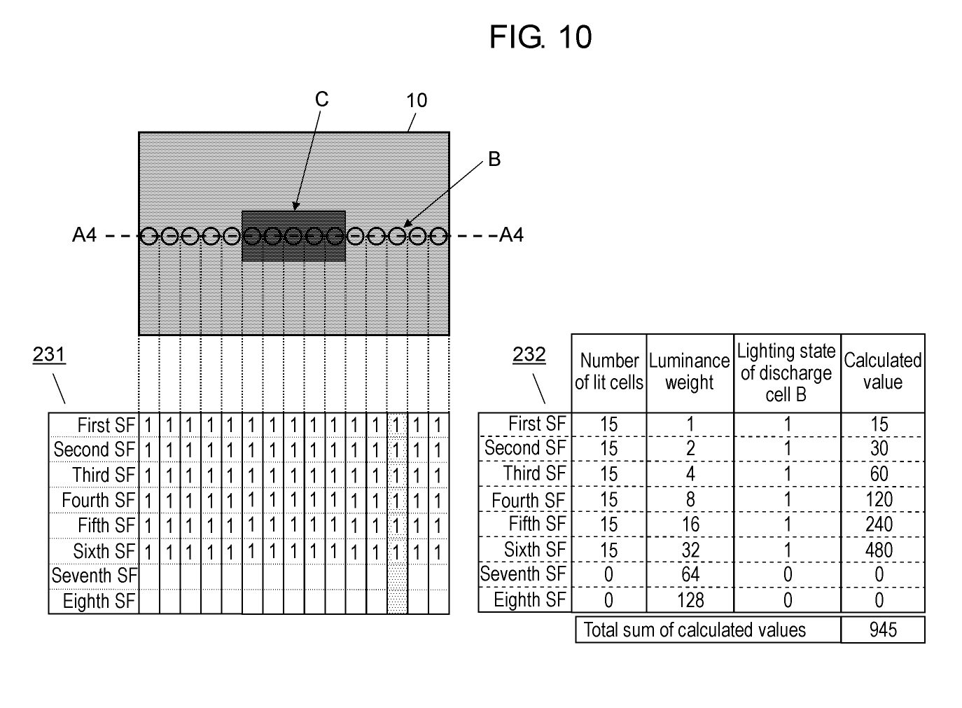

First, a description is provided for a “load value” in this exemplary embodiment, with reference to FIG. 9. Next, a description is provided for a “maximum load value” in this exemplary embodiment, with reference to FIG. 10.

FIG. 9 is a schematic drawing for explaining a method for calculating a “load value” in accordance with the exemplary embodiment of the present invention. This drawing shows a schematic diagram of the display image of the “window pattern” of FIG. 5A displayed on panel 10 and tables of lighting state 221 and calculated value 222. Lighting state 221 of FIG. 9 is a schematic table showing lighting or non-lighting in each discharge cell on line A3-A3 in panel 10 of FIG. 9 in each subfield. The horizontal columns show display positions on line A3-A3 in panel 10; the vertical columns show the subfields. Further, “1” represents lighting, and the blank represents non-lighting. Calculated value 222 of FIG. 9 is a schematic table showing the method for calculating a “load value” in this exemplary embodiment. The horizontal columns show “number of lit cells”, “luminance weight”, “lighting state of discharge cell B”, and “calculated value” in this order from the left of the table; the vertical columns show the subfields. In this exemplary embodiment, for simplifying the explanation, the number of discharge cells in the line direction is set to 15. Therefore, the following description is provided, assuming that 15 discharge cells are disposed on line A3-A3 in panel 10 of FIG. 9. Actually, the following operations are performed on a number of discharge cells in the line direction of panel 10 (e.g. 1920×3).

Assume that the lighting states of 15 discharge cells disposed on line A3-A3 in panel 10 of FIG. 9 in the respective subfields are as shown in lighting state 221, for example. That is, five discharge cells in the center included in region C in panel 10 of FIG. 9 are lit in the first SF through the third SF, and unlit in the fourth SF through the eighth SF. Further, five discharge cells on the left side and five discharge cells on the right side excluded from region C are lit in the first SF through the sixth SF, and unlit in the seventh SF and the eighth SF.

When the 15 discharge cells disposed on line A3-A3 are in such a lighting state, the “load value” of one of the discharge cells, e.g. discharge cell B in the diagram, is obtained in the following manner.

First, the number of lit cells out of 15 discharge cells disposed on line A3-A3 is calculated in each subfield. In the example of FIG. 9, all 15 discharge cells on line A3-A3 are lit in the first SF through the third SF. Thus, the number of lit cells in each of the first SF through the third SF is “15”. Ten out of the 15 discharge cells on line A3-A3 are lit in each of the fourth SF through the sixth SF. Thus, the number of lit cells in each of the fourth SF through the sixth SF is “10”. All 15 discharge cells on line A3-A3 are unlit in the seventh SF and the eighth SF. Thus, the number of lit cells in each of the seventh SF and the eighth SF is “0”. In calculated value 222 of FIG. 9, the columns of “number of lit cells” corresponding to the first SF through the third SF are filled with “15”, those corresponding to the fourth SF through the sixth SF are filled with “10”, and those corresponding to the seventh SF and the eighth SF are filled with “0”.

Next, the number of lit cells in each subfield thus obtained is multiplied by the luminance weight of the corresponding subfield and the lighting state of discharge cell B in the subfield. This multiplication result is a “calculated value” in this exemplary embodiment. In this exemplary embodiment, as shown in the columns of “luminance weight” in calculated value 222 of FIG. 9, the respective luminance weights of the first SF through the eighth SF are 1, 2, 4, 8, 16, 32, 64, and 128 in this order. In this exemplary embodiment, lighting is “1” and non-lighting is “0”. Thus, as shown in the columns of “lighting state of discharge cell B” in calculated value 222, the respective lighting states of discharge cell B in the first SF through the eighth SF are 1, 1, 1, 1, 1, 1, 0, and 0 in this order. Therefore, as shown in the columns of “calculated value” in calculated value 222, the respective multiplication results in the first SF through the eighth SF are 15, 30, 60, 80, 160, 320, 0, and 0 in this order. Then, in this exemplary embodiment, the total sum of the calculated values is obtained. In the example shown in calculated value 222 of FIG. 9, the total sum of the calculated values is “665”. This total sum is the “load value” in discharge cell B. In this exemplary embodiment, such operations are performed on each discharge cell, and thereby a “load value” is obtained for each discharge cell.

FIG. 10 is a schematic drawing for explaining a method for calculating a “maximum load value” in accordance with the exemplary embodiment of the present invention. This drawing shows a schematic diagram of the display image of the “window pattern” of FIG. 5A displayed on panel 10 and tables of lighting state 231 and calculated value 232. Lighting state 231 of FIG. 10 is a schematic table showing lighting or non-lighting in each subfield when the lighting state of discharge cell B is applied to all the discharge cells on line A4-A4 in panel 10 of FIG. 10. The horizontal columns show display positions on line A4-A4 in panel 10; the vertical columns show the subfields. Calculated value 232 of FIG. 10 is a schematic table showing the method for calculating a “maximum load value” in this exemplary embodiment. The horizontal columns show “number of lit cells”, “luminance weight”, “lighting state of discharge cell B”, and “calculated value” in this order from the left of the table; the vertical columns show the subfields.

In this exemplary embodiment, a “maximum load value” is calculated in the following manner. For instance, when the “maximum load value” in discharge cell B is calculated, the number of lit cells in each subfield is calculated, assuming that every discharge cell on line A4-A4 is in a lighting state equal to that of discharge cell B, as shown in lighting state 231 of FIG. 10. As shown in the respective columns of “lighting state of discharge cell B” corresponding to the first SF through the eighth SF in calculated value 222 of FIG. 9, the lighting states of discharge cell B in the first SF through the eighth SF are 1, 1, 1, 1, 1, 1, 0, and 0 in this order. Then, the lighting states are allocated to all the discharge cells on line A4-A4. Thus, the lighting states of all the discharge cells on line A4-A4 are “1” in the first SF through the sixth SF, and “0” in the seventh SF and the eighth SF, as shown in the respective columns in lighting state 231 of FIG. 10. Therefore, the numbers of lit cells in the first SF through the eighth SF are 15, 15, 15, 15, 15, 15, 0, and 0 in this order, as shown in the columns of “number of lit cells” in calculated value 232 of FIG. 10. However, in this exemplary embodiment, each of the discharge cells on line A4-A4 is not actually in the lighting state shown in lighting state 231. The lighting states shown in lighting state 231 are those when it is assumed that each of the discharge cells is in a lighting state equal to that of discharge cell B for calculation of a “maximum load value”. The “number of lit cells” shown in calculated value 232 is the number of lit cells based on that assumption.

Next, the number of lit cells in each subfield thus obtained is multiplied by the luminance weight of the corresponding subfield and the lighting state of discharge cell B in the subfield. As described above, in this exemplary embodiment, as shown in the respective columns of “luminance weight” in calculated value 232 of FIG. 10, the luminance weights of the first SF through the eighth SF are 1, 2, 4, 8, 16, 32, 64, and 128 in this order. Further, as shown in the respective columns of “lighting state of discharge cell B” in calculated value 232, the lighting states of discharge cell B in the first SF through the eighth SF are 1, 1, 1, 1, 1, 1, 0, and 0 in this order. Therefore, as shown in the respective columns of “calculated value” in calculated value 232, the multiplication results in the first SF through the eighth SF are 15, 30, 60, 120, 240, 480, 0, and 0 in this order. Then, the total sum of the calculated values is obtained. In the example shown in calculated value 232 of FIG. 10, the total sum of the calculated values is “945”. This total sum is the “maximum load value” in discharge cell B. In this exemplary embodiment, such operations are performed on each discharge cell, and thereby a “maximum load value” is obtained for each discharge cell.

The “maximum load value” in discharge cell B may be obtained also in the following manner. The number of all discharge cells on display electrode pair 24 is multiplied by the luminance weight of the corresponding subfield. Next, the multiplication result is multiplied by the lighting state of discharge cell B in the subfield. Then, the total sum of these calculated values is obtained. Also by such a calculation method, the result equal to that of the above operations can be obtained. In the example shown in FIG. 10, the number of all discharge cells formed on display electrode pair 24 is “15”. The luminance weights of the respective subfields are 1, 2, 4, 8, 16, 32, 64, and 128 in this order from the first SF. The lighting states of discharge cell B in the respective subfields are 1, 1, 1, 1, 1, 1, 0, and 0 in this order from the first SF. Thus, the multiplication results of these values are 15, 30, 60, 120, 240, 480, 0, and 0 in this order from the first SF. Therefore, the total sum of these multiplication results is “945”, which is equal to the result of the above operations.

Further, in this exemplary embodiment, using a numerical value obtained with the following Expression (1), a correction gain in each discharge cell is calculated.

(Maximum load value−Load value)/Maximum load value Expression (1)

For example, from the “load value”=665 and the “maximum load value”=945 in the above discharge cell B, the following numerical value:

(945−665)/945=0.296

is obtained. By multiplying the thus calculated numerical value by a predetermined coefficient (a coefficient predetermined for the characteristics of the panel, for example), the correction gain is calculated.

Correction gain=Result of Expression (1)×Predetermined coefficient Expression (2)

Further, in this exemplary embodiment, the correction gain calculated with Expression (2) is smoothed in response to the image signal. For this smoothing, a general low-pass filter is used. Then, an adjusted correction gain after smoothing is substituted into the following Expression (3) so as to correct the input image signal.

Output image signal=Input image signal−Input image signal×Adjusted correction gain Expression (3)

In this manner, in this exemplary embodiment, a loading correction is made to the display image, using the adjusted correction gain.

In recent large-screen, high-definition panel 10, the drive load on scan electrodes 22 and sustain electrodes 23 tends to increase. In plasma display apparatus 1 including such panel 10, a difference in drive load between display electrode pairs 24 tends to increase and cause a loading phenomenon, depending on the pattern of the display image.

However, in this exemplary embodiment, a loading correction can be made accurately in the following manner. As shown in Expression (1) and Expression (2), by calculating a “load value” and a “maximum load value” and using these values to calculate a correction gain for a loading correction, the correction gain in response to an expected increase in emission luminance can be calculated accurately. In order to prevent the magnitude of the correction gain from differing between the R, G, and B discharge cells forming one pixel, the average value, (or the maximum value, or the minimum value, or the intermediate value) of the correction gains calculated in the R, G, and B discharge cells may be used as a correction gain for the pixel.

On the other hand, as obvious from the explanation with reference to FIG. 9 and FIG. 10, the calculated values of the load value and the maximum load value depend more largely on the lighting subfield having the heaviest luminance weight (hereinafter, being referred to as “maximum lighting subfield”) than on the other subfields. Thus, in an area where the maximum lighting subfield changes, the correction gain can change more significantly than in an area where the maximum lighting subfield does not change.

When a loading correction is made to the display image in this exemplary embodiment, as shown by Expression (3), an input image signal is multiplied by a correction gain and the multiplication result is subtracted from the input image signal. Thus, when the gradation value (brightness) of the input image signal only slightly changes but the maximum lighting subfield changes between adjacent pixels, the correction gain changes relatively significantly and the loading correction using the correction gains can cause an unnatural change in the brightness in the display image.

A description is provided for an example of this phenomenon, using pixel G1, pixel G2, and pixel G3 adjacent to each other in the extending direction of display electrode pair 24 (hereinafter, being referred to as “horizontal direction”). In this example, one field is formed of eight subfields, i.e. the first SF through the eighth SF, and the first SF through the eighth SF have respective luminance weights of 1, 2, 4, 8, 16, 32, 64, and 128. All of the R, G, and B discharge cells forming one pixel have an equal gradation value (in an equal lighting state).

For instance, assume that the gradation value of pixel G1 is “126”, that of pixel G2 adjacent to pixel G1 is “127”, and that of pixel G3 adjacent to pixel

G2 is “128”. At this time, the lighting states in the first SF through the eighth SF are 0, 1, 1, 1, 1, 1, 1, 0 with pixel G1, 1, 1, 1, 1, 1, 1, 1, 0 with pixel G2, and 0, 0, 0, 0, 0, 0, 0, 1 with pixel G3. Here, “1” represents lighting and “0” represents non-lighting.

In this case, the gradation value changes from pixel G1 to adjacent pixel G2 by “1”, and from adjacent pixel G2 to adjacent pixel G3 by “1” similarly. However, while the maximum lighting subfield of pixel G1 and pixel G2 is the seventh SF, and that of pixel G3 is the eighth SF. This raises the possibility that the change in correction gain from pixel G2 to pixel G3 is larger than the change in correction gain from pixel G1 to pixel G2. If the correction gains are used for a loading correction without any adjustment, the luminance difference from pixel G2 to pixel G3 is larger than the luminance difference from pixel G1 to pixel G2. This can cause an unnatural change in the brightness in the display image.

Then, in this exemplary embodiment, a change in brightness between adjacent pixels is determined in response to the image signal. Further, in an area where the change in brightness between adjacent pixels is determined to be relatively small, the correction gain is smoothed such that the amount of change in the correction gain is reduced. That is, in this exemplary embodiment, a change in the maximum lighting subfield between adjacent pixels is detected. Further, in an area where the maximum lighting subfield considerably changes, the correction gains calculated in correction gain calculator 62 are used for a loading correction without any adjustment. In an area where the above phenomenon is not determined, the adjusted correction gains obtained by smoothing the correction gains with a low-pass filter are used for a loading correction. These operations can prevent an unnatural change in the brightness in the display image caused by loading correction.

Next, correction gain adjuster 64 is detailed.

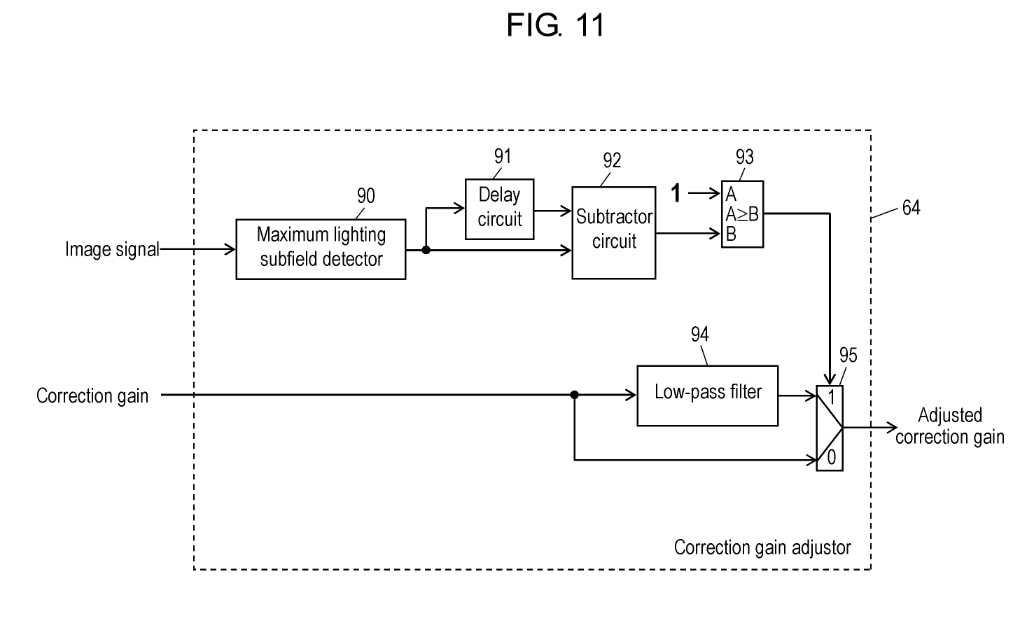

FIG. 11 is a circuit block diagram of correction gain adjustor 64 in accordance with the exemplary embodiment of the present invention. Correction gain adjustor 64 has maximum lighting subfield detector 90, delay circuit 91, subtractor circuit 92, comparator circuit 93, low-pass filter 94, and selector circuit 95.

Maximum lighting subfield detector 90 detects the lighting subfield having the heaviest luminance weight, i.e. the maximum lighting subfield, for each discharge cell. Then, the maximum lighting subfield detector outputs a numerical value representing the maximum lighting subfield. Specifically, the maximum lighting subfield detector allocates numerical values based on the order of magnitude of the luminance weight to the respective subfields, detects the maximum lighting subfield, and outputs the numerical value allocated to the detected maximum lighting subfield.

For instance, when one field is formed of eight subfields (the first SF, the second SF, . . . , the eighth SF), and the first SF through the eighth SF have respective luminance weights of 1, 2, 4, 8, 16, 32, 64, and 128, consecutive numerical values based on the order of magnitude of the luminance weight, e.g. 1, 2, 3, 4, 5, 6, 7, and 8, are allocated to the respective subfields of the first SF through the eighth SF. These numerical values are not based on the order of subfields but on the order of magnitude of the luminance weight. Therefore, when the first SF through the eighth SF have respective luminance weights of 1, 4, 16, 64, 2, 8, 32, and 128, the consecutive numerical values based on the order of magnitude of the luminance weight are 1, 3, 5, 7, 2, 4, 6, and 8. These numerical values are allocated to the respective subfields of the first SF through the eighth SF.

Then, the lighting subfield having the heaviest luminance weight (the maximum lighting subfield) is detected, and the numerical value allocated to the subfield is output. In the above example, maximum lighting subfield detector 90 outputs “8” when the maximum lighting subfield is a subfield which has a luminance weight of 128, and outputs “7” when the maximum lighting subfield is a subfield which has a luminance weight of 64.

The numerical values allocated to the respective subfields may be any consecutive numerical values in ascending order or descending order as long as the numerical values are based on the order of magnitude of the luminance weight. For instance, when the first SF through the eighth SF have respective luminance weights of 1, 2, 4, 8, 16, 32, 64, and 128, the numerical values allocated to the respective subfields of the first SF through the eighth SF may be set to 8, 7, 6, 5, 4, 3, 2, and 1. In that case, when the maximum lighting subfield is the eighth SF, “1” is output, and when the maximum lighting subfield is the seventh SF, “2” is output.

Delay circuit 91 delays the numerical value output from maximum lighting subfield detector 90 by a predetermined time. The predetermined time is a time for one pixel, for example. The time for one pixel can be represented as the time obtained by dividing the time for one field of an image signal by the number of pixels (e.g. 1920×1080 pixels) forming panel 10.

Subtractor circuit 92 subtracts, from the numerical value output from maximum lighting subfield detector 90, the numerical value obtained by delaying the output from maximum lighting subfield detector 90 in delay circuit 91, and outputs the absolute value of the subtraction result. With these operations, a change in the maximum lighting subfield between the discharge cells of the same color (between R discharge cells, between G discharge cells, and between B discharge cells) in adjacent two pixels can be detected. At this time, when the delay time in delay circuit 91 is set to a time for one pixel, the “adjacent two pixels” are those adjacent to each other in the horizontal direction.

Comparator circuit 93 compares the output from subtractor circuit 92 with a preset threshold (e.g. “1”). When the output from subtractor circuit 92 is equal to or smaller than the threshold, the comparator circuit outputs “1”, and otherwise outputs “0”. This operation determines whether a change in the maximum lighting subfield detected in subtractor circuit 92 is large or not.

Low-pass filter 94 is formed of a generally-used finite impulse response (FIR) filter for averaging an input signal and a delay signal obtained by delaying the input signal, and smoothes the input signal, which is a correction gain (a correction gain calculated in correction gain calculator 62). At this time, the correction gain can be smoothed in the horizontal direction by setting the delay time when the input signal is delayed to a time corresponding to one pixel, for example.

Selector circuit 95 selects and outputs one of two inputs based on the output from comparator circuit 93. Specifically, when the output from comparator circuit 93 is “1”, the selector circuit selects the output from low-pass filter 94, i.e. the correction gain smoothed with low-pass filter 94. When the output from comparator circuit 93 is “0”, the selector circuit selects and outputs the correction gain before undergoing low-pass filter 94. This output is an adjusted correction gain output from correction gain adjustor 64.

The configuration of low-pass filter 94 is not limited to the above. In other usable configurations, the delay time in delaying the input signal is variable, and the delay time can be switched adaptively in response to an image signal. The smoothing means (filter) for use in low-pass filter 94 is not limited to the FIR filter. Other filters, such as an infinite impulse response (IIR) filter and a median filter, can be used. Preferably, the above delay time, the configuration of the filter, or the like, i.e. the characteristics of the low-pass filter, is set optimally based on the characteristics of panel 10, the specifications of plasma display apparatus 1, the visibility tests of the display images, or the like.

In some cases, the output values from comparator circuit 93 can differ from each other between the R, G, and B discharge cells that form one pixel. In order to prevent mixing a correction gain before undergoing low-pass filter 94 and a correction gain after having undergone low-pass filter 94 in one pixel, selector circuit 95 performs the following operation. When the output value from comparator circuit 93 is “1” in at least one of the R, G, and B discharge cells forming one pixel, the correction gain having undergone low-pass filter 94 is selected in all the discharge cells of the pixel.

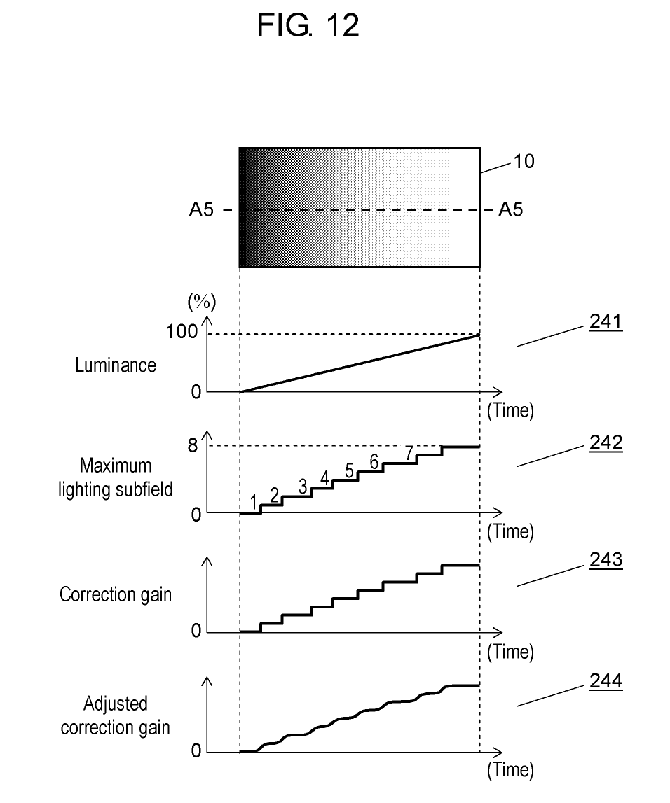

A description is provided for an example of this adjusted correction gain, with reference to the accompanying drawing. FIG. 12 is a schematic diagram for explaining an example of an adjusted correction gain in accordance with the exemplary embodiment of the present invention. Herein, delay circuit 91 is set so as to delay an input signal by a time for one pixel. Low-pass filter 94 is set so as to smooth the correction gain in the horizontal direction.

The display image shown on panel 10 of FIG. 12 is an example of an image (e.g. a horizontal ramp image) where a change in brightness is relatively small in the horizontal direction. Luminance level 241 shows a luminance level of an image signal on line A5-A5 shown in panel 10 of FIG. 12, and the vertical axis shows the magnitude of the luminance level. Maximum lighting subfield 242 shows the maximum lighting subfield detected on line A5-A5 in panel 10 of FIG. 12, and the vertical axis shows the magnitude of the maximum lighting subfield. In this example, one field is formed of eight subfields, the first SF through the eighth SF have respective luminance weights of 1, 2, 4, 8, 16, 32, 64, and 128, and numerical values of 1, 2, 3, 4, 5, 6, 7, and 8 are allocated to the respective subfields of the first SF through the eighth SF. Correction gain 243 shows a correction gain calculated in correction gain calculator 62 on line A5-A5 in panel 10 of FIG. 12; the vertical axis shows the magnitude of the correction gain. Adjusted correction gain 244 shows a correction gain adjusted in correction gain adjustor 64 on line A5-A5 in panel 10 of FIG. 12, and the vertical axis shows the magnitude of the adjusted correction gain. In each of the diagrams of luminance level 241, maximum lighting subfield 242, correction gain 243, and adjusted correction gain 244, the horizontal axis shows a time (one horizontal synchronization period).

As shown in luminance level 241 of FIG. 12, even when the luminance level changes smoothly in the horizontal direction and a change in the brightness in the horizontal direction is relatively small, the maximum lighting subfield changes as shown in maximum lighting subfield 242. Thus, as shown in correction gain 243, the correction gain calculated in correction gain calculator 62 can more significantly change in an area where the maximum lighting subfield changes than in an area where the maximum lighting subfield does not change. When this correction gain is used for a loading correction without any adjustment, an unnatural change in luminance can occur in the display image.

At this time, in this exemplary embodiment, when the threshold in comparator circuit 93 is “1”, for example, and a change in the maximum lighting subfield between adjacent pixels is within one step, the adjusted correction gain is a correction gain smoothed by low-pass filter 94 in the horizontal direction as shown in adjusted correction gain 244. Therefore, using this adjusted correction gain for a loading correction can prevent an unnatural change in the luminance in the display image after the loading correction.

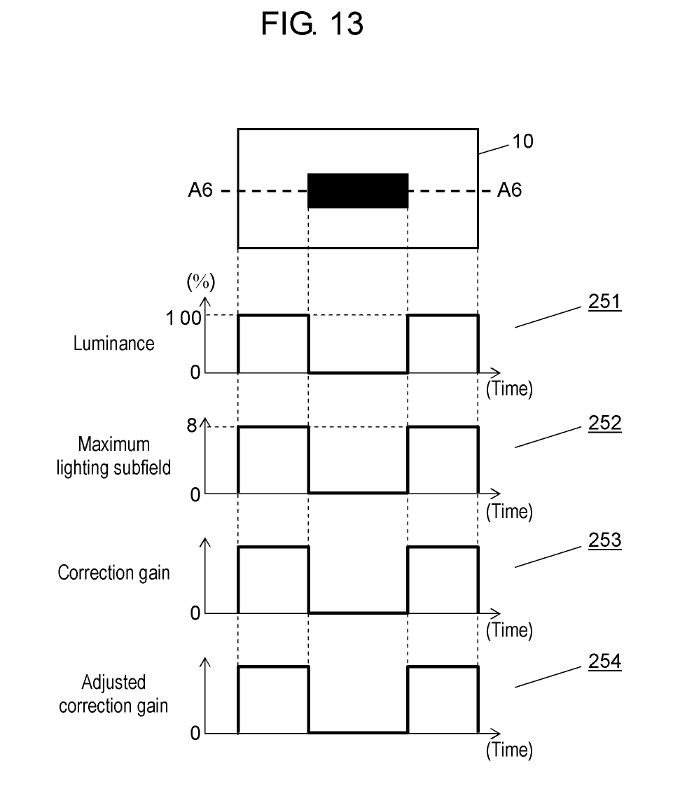

FIG. 13 is a schematic diagram for explaining another example of the adjusted correction gain in accordance with the exemplary embodiment of the present invention. The respective settings are the same as those in FIG. 12 except for the display image.

The display image shown on panel 10 of FIG. 13 is an example of an image where a change in brightness is relatively large in the horizontal direction. This example schematically shows a display image when a window pattern where the luminance level in the center portion is 0% and the luminance level in the peripheral portion is 100% is displayed on panel 10. Luminance level 251 shows a luminance level of an image signal on line A6-A6 shown in panel 10 of FIG. 13, and the vertical axis shows the magnitude of the luminance level. Maximum lighting subfield 252 shows the maximum lighting subfield detected on line A6-A6 in panel 10 of FIG. 13, and the vertical axis shows the magnitude of the maximum lighting subfield. Correction gain 253 shows a correction gain calculated in correction gain calculator 62 on line A6-A6 in panel 10 of FIG. 13, and the vertical axis shows the magnitude of the correction gain. Adjusted correction gain 254 shows a correction gain adjusted in correction gain adjustor 64 on line A6-A6 in panel 10 of FIG. 13, and the vertical axis shows the magnitude of the adjusted correction gain. In each of the diagrams of luminance level 251, maximum lighting subfield 252, correction gain 253, and adjusted correction gain 254, the horizontal axis shows a time (one horizontal synchronization period).

As shown in luminance level 251 of FIG. 13, when the luminance level considerably changes in the horizontal direction and a loading correction is made using a correction gain smoothed in the horizontal direction by low-pass filter 94, the following problem can arise. That is, even though the luminance level changes steeply in the original image signal, the luminance level changes gently in the image signal after the loading correction. Thus, an image having blurred contours can be displayed on panel 10.

At this time, when the threshold in comparator circuit 93 is “1” and a change in the maximum lighting subfield between adjacent pixels is equal to or larger than two steps (“8” in the example of FIG. 13), the adjusted correction gain is a correction gain without undergoing low-pass filter 94 as shown in adjusted correction gain 254. Thus, the loading correction using this adjusted correction gain can prevent blurred contours in an area where the luminance level changes steeply in the original image signal. Therefore, an image having sharp contours can be displayed on panel 10.

As described above, in this exemplary embodiment, a “load value” and a “maximum load value” are calculated so as to provide a correction gain for each discharge cell. With this structure, even in plasma display apparatus 1 that includes panel 10 having a large difference in the voltage drop in sustain pulse between the discharge cells formed on one display electrode pair 24, a difference in drive impedance between display electrode pairs 24 can be detected accurately. Thus, a correction gain optimum for the lighting state of each discharge cell can be calculated. Therefore, a correction gain in response to an expected increase in the emission luminance caused by a loading phenomenon can be calculated appropriately, and the loading correction can be made appropriately.

Further, in this exemplary embodiment, a change in brightness between adjacent pixels is determined in response to the image signal. In an area where the change in brightness between adjacent pixels is determined to be relatively large, correction gains calculated in correction gain calculator 62 are used for a loading correction. In an area where the change in brightness between adjacent pixels is determined to be relatively small, correction gains smoothed with low-pass filter 94 are used for a loading correction. Thus, when the change in brightness between adjacent pixels is small, correction gains smoothed with the low-pass filter can be used for a loading correction. When the change in brightness between adjacent pixels is large, unsmoothed correction gains can be used for a loading correction. This operation can make an accurate loading correction while preventing an unnatural change in the luminance in the display image. Therefore, in plasma display apparatus 1 that includes large-screen, high-definition panel 10, the image display quality can be enhanced considerably.

In an area where pixels having light luminance weights in the maximum lighting subfield are adjacent to each other, it is considered that the maximum lighting subfield can change at approximately two steps even with a small change in gradation value. In order to smooth the correction gain in such a case, the numerical values to be allocated to the respective subfields in the order of magnitude of the luminance weight may be weighed based on magnitude of the luminance weight. For instance, when the respective subfields have luminance weights of 1, 2, 4, 8, 16, 32, 64, and 128, the numerical values of 0.5, 1, 2, 3, 4, 5, 6, and 7 may be allocated to the respective subfields.

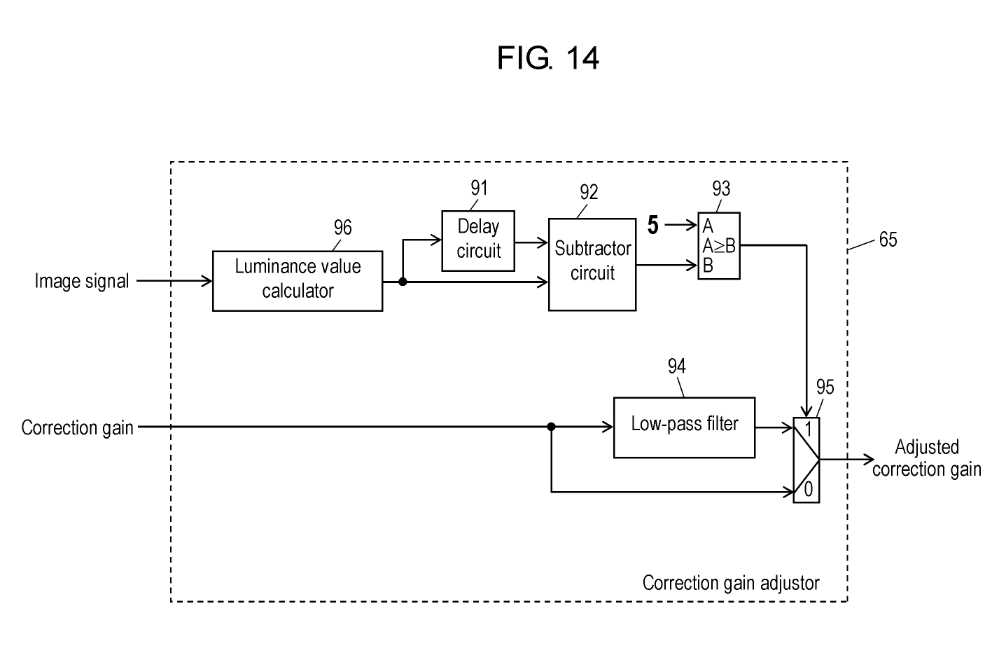

In the structure described in this exemplary embodiment, the change in brightness between adjacent pixels is determined by detecting the maximum lighting subfield. However, the present invention is not limited to this structure. FIG. 14 is a circuit block diagram showing another configuration example of the correction gain adjustor in accordance with the exemplary embodiment of the present invention. Correction gain adjustor 65 is configured to have luminance value calculator 96 for calculating a luminance value for each pixel instead of maximum lighting subfield detector 90. With this configuration, delay circuit 91 and subtractor circuit 92 can calculate a difference in luminance value (an absolute value) between adjacent pixels. Thus, when the calculation result is compared with a threshold (e.g. “5”) preset in comparator circuit 93, a change in brightness between adjacent pixels can be determined. Even such a configuration, for example, can provide the advantage, which is an object of the present invention.

In this exemplary embodiment, a description is provided for the operation of each circuit, using pixels adjacent to each other in the horizontal direction. When the “horizontal direction” in the description of this exemplary embodiment is replaced with “the extending direction (vertical direction) of data electrodes 32”, and “a delay for one pixel” is replaced with “a delay for one horizontal synchronization period”, the advantage same as the above can be obtained also in pixels adjacent to each other in the vertical direction.

Though omitted in the description for correction gain adjustor 64 in FIG. 11, at the stage before the detection of the maximum lighting subfield in maximum lighting subfield detector 90, gradation values of image signals are converted into image data once, using a coding table for correlating gradation values with lighting and non-lighting in the respective subfields. Similar operation is performed when a load value and a maximum load value are calculated in number of lit cells calculator 60.

The specific numerical values, such as a threshold for use in comparator circuit 93, a delay time in low-pass filter 94, the number of subfields, and a luminance weight, in this exemplary embodiment are only examples, and these numerical values are not limited to the above. Preferably, each numerical value is set optimally based on the characteristics of panel 10, the specifications of plasma display apparatus 1, the visibility tests of the display images, the experiments of displaying images likely to have loading phenomena on panel 10, or the like.

In the structure described in this exemplary embodiment, the luminance weight of each subfield is multiplied by the lighting state of a discharge cell in the subfield in calculation of a “load value” and a “maximum load value”. Instead of the luminance weight, the number of sustain pulses in each subfield, for example, may be used.

When generally-used image processing called error diffusion is performed, the following problem can arise. An increase in the error amount diffused at a changing point of the gradation value (a boundary of a pattern of a display image) emphasizes the boundary in the boundary portion having a large luminance change, and makes the image look unnatural. In order to reduce this problem, a correction value for error diffusion may be randomly added to or subtracted from the calculated correction gain so as to give a random change to the correction gain. Such processing can reduce the problems of emphasizing the boundary of the pattern and making the image look unnatural in error diffusion.

“To estimate the amount of loading phenomenon” described in this exemplary embodiment means estimating the amount of loading phenomenon when an image is displayed on panel 10 without any loading correction made on the image signal, and does not mean estimating the amount of loading phenomenon of a display image having undergone a loading correction.

The exemplary embodiment of the present invention can also be applied to a method for driving a panel by so-called two-phase driving. In the two-phase driving, scan electrode SC1-scan electrode SCn are divided into a first scan electrode group and a second scan electrode group. Further, each address period is divided into two address periods: a first address period where a scan pulse is applied to each scan electrode belonging to a first scan electrode group; and a second address period where the scan pulse is applied to each scan electrode belonging to a second scan electrode group. Also in the two-phase driving, the advantage similar to the above can be obtained.

The exemplary embodiment of the present invention is also effective in a panel having an electrode structure where a scan electrode is adjacent to a scan electrode and a sustain electrode is adjacent to a sustain electrode. In this electrode structure, the electrodes are arranged on the front substrate in the following order: . . . , a scan electrode, a scan electrode, a sustain electrode, a sustain electrode, a scan electrode, a scan electrode . . . .

Each circuit block shown in this exemplary embodiment of the present invention may be formed as an electric circuit that performs each operation shown in the exemplary embodiment, or formed of a microcomputer, for example, programmed so as to perform the similar operations.

In the examples described in this exemplary embodiment, one pixel is formed of discharge cells of R, G, and B three colors. Also a panel that includes pixels, each formed of discharge cells of four or more colors, can use the configuration shown in this exemplary embodiment and provide the similar advantage.

The specific numerical values shown in the exemplary embodiment of the present invention are set based on the characteristics of panel 10 that has a 50-inch screen and 1080 display electrode pairs 24, and only show examples in the exemplary embodiment. The present invention is not limited to these numerical values. Preferably, each numerical value is set optimally for the characteristics of the panel, the specifications of the plasma display apparatus, or the like. Variations are allowed for each numerical value within the range in which the above advantage can be obtained. The number of subfields, the luminance weights of the respective subfields, or the like is not limited to the values shown in the exemplary embodiment of the present invention. The subfield structure may be switched in response to an image signal, for example.

### INDUSTRIAL APPLICABILITY

Even in a large-screen, high-definition panel, the present invention can enhance image display quality by reducing a change in the luminance in the display image caused by a difference in drive load between display electrode pairs and preventing an unnatural change in the luminance in the display image. Thus, the present invention is useful as a plasma display apparatus and as a driving method for a panel.

### REFERENCE MARKS IN THE DRAWINGS

1 Plasma display apparatus
10 Panel
21 Front substrate
22 Scan electrode
23 Sustain electrode
24 Display electrode pair
25, 33 Dielectric layer
26 Protective layer
31 Rear substrate
32 Data electrode
34 Barrier rib
35 Phosphor layer
41 Image signal processing circuit
42 Data electrode driver circuit
43 Scan electrode driver circuit
44 Sustain electrode driver circuit
45 Timing generation circuit
60 Number of lit cells calculator
61 Load value calculator
62 Correction gain calculator
64, 65 Correction gain adjustor
68 Multiplier
69 Corrector
70 Loading correction part
90 Maximum lighting subfield detector
91 Delay circuit
92 Subtractor circuit
93 Comparator circuit
94 Low-pass filter
95 Selector circuit
96 Luminance value calculator

1. A plasma display apparatus comprising:
a plasma display panel including:
a plurality of discharge cells, each of the discharge cells having a display electrode pair that includes a scan electrode and a sustain electrode,
a plurality of pixels, each of which has a plurality of discharge cells emitting light in different colors,
wherein the plasma display panel is driven by a subfield method such that a plurality of subfields having respective luminance weights is set in one field; and
an image signal processing circuit for converting an input image signal into image data representing lighting and non-lighting in each subfield of each discharge cell,
wherein the image signal processing circuit includes:
a number of lit cells calculator for calculating a number of discharge cells to be lit in each display electrode pair in each subfield;
a load value calculator for calculating a load value of each discharge cell based on a calculation result by the number of lit cells calculator;
a correction gain calculator for calculating a correction gain of each discharge cell based on a calculation result by the load value calculator;
a correction gain adjustor for smoothing the correction gain in response to an image signal; and
a corrector for subtracting, from the input image signal, a multiplication result of an adjusted correction gain output from the correction gain adjustor and the input image signal.

2. The plasma display apparatus of claim 1, wherein the correction gain adjustor includes:
a maximum lighting subfield detector for detecting a lighting subfield having a heaviest luminance weight;
a delay circuit for delaying an output from the maximum lighting subfield detector by a predetermined time;
a comparator circuit for comparing a difference between the output from the maximum lighting subfield detector and an output from the delay circuit with a preset threshold;
a low-pass filter for smoothing the correction gain; and
a selector circuit for selecting and outputting one of the correction gain and an output from the low-pass filter, based on a comparison result by the comparator circuit.

3. The plasma display apparatus of claim 1, wherein the correction gain adjustor includes:
a luminance value calculator for calculating a gradation value of a luminance for each pixel;
a delay circuit for delaying an output from the luminance value calculator by a predetermined time;
a comparator circuit for comparing a difference between the output from the luminance value calculator and an output from the delay circuit with a preset threshold;
a low-pass filter for smoothing the correction gain; and
a selector circuit for selecting and outputting one of the correction gain and an output from the low-pass filter, based on a comparison result by the comparator circuit.

4. A driving method for a plasma display panel,
the plasma display panel including:
a plurality of discharge cells, each of the discharge cells having a display electrode pair that includes a scan electrode and a sustain electrode,
a plurality of pixels, each of which has a plurality of discharge cells emitting light in different colors,
wherein the plasma display panel is driven by a subfield method such that a plurality of subfields having respective luminance weights is set in one field,
the driving method comprising:
calculating a number of discharge cells to be lit in each display electrode pair and in each subfield;
calculating a load value of each discharge cell based on the number of discharge cells to be lit, and calculating a correction gain of each discharge cell based on the load value;
smoothing the correction gain in response to an image signal so as to generate an adjusted correction gain; and
multiplying the adjusted correction gain by the input image signal and subtracting a multiplication result from the input image signal for providing the input image signal with a loading correction.

5. The driving method for the plasma display panel of claim 4 comprising:
smoothing the correction gain by passing the correction gain through a low-pass filter;
detecting a lighting subfield having a heaviest luminance weight as a maximum lighting subfield;
delaying the maximum lighting subfield by a predetermined time;
comparing a difference between the maximum lighting subfield and the maximum lighting subfield delayed by the predetermined time with a preset threshold; and
selecting one of the correction gain before undergoing the low-pass lifter and the correction gain after having undergone the low-pass filter based on the comparison result for generating the adjusted correction gain.

6. The driving method for the plasma display panel of claim 4 comprising:
smoothing the correction gain by passing the correction gain through a low-pass filter;
calculating a gradation value of a luminance for each pixel;
delaying the calculated gradation value of the luminance by a predetermined time;
comparing a difference between the calculated gradation value of the luminance and the gradation value of the luminance delayed by the predetermined time with a preset threshold; and
selecting one of the correction gain before undergoing the low-pass filter and the correction gain after having undergone the low-pass filter based on the comparison result for generating the adjusted correction gain.
